(19) United States
(12) Patent Application Publication
(10) Pub. No.: US 2006/0225971 A1
(43) Pub. Date: Oct. 12, 2006

(54) Braking a vehicle in the context of an emergency stop

(76) Inventor: Gabriel Jaeger, Abstatt (DE)

Correspondence Address: KENYON & KENYON LLP, ONE BROADWAY, NEW YORK, NY, 10004, US

(21) Appl. No.: 11/393,982

(22) Filed: Mar. 29, 2006

(30) Foreign Application Priority Data
Apr. 7, 2005 (DE) 102005016001.8

(51) Int. Cl. F16D 65/14

(52) U.S. Cl. 188/106 P

(57) ABSTRACT

A method for braking a vehicle in the context of an emergency stop with the aid of a service braking system and a second braking system. The braking operation can be carried out uniformly and continuously if a positioning member of the service braking system and a positioning member of the second braking system are actuated simultaneously, the braking pressure exerted by the positioning member of the service braking system being reduced in the course of the braking operation, and the braking pressure exerted by the positioning member of the second braking system being increased.

### FIELD OF THE INVENTION

The present invention relates to a method for braking a vehicle in the context of an emergency stop, as well as a braking system having an emergency stop function.

### BACKGROUND INFORMATION

Modern vehicles are more and more often being equipped with emergency stop apparatuses with which the vehicle can be braked in critical driving situations. Such systems usually encompass an operating element such as, for example, a pushbutton, that can be actuated by the driver in order to initiate an emergency stop. The emergency stop request is detected by a control unit connected to the operating element, which unit thereupon triggers a positioning member of the service braking system, such as e.g. a hydraulic pump, in order to build up pressure in the wheel brakes and decelerate the vehicle. Other vehicles additionally or alternatively encompass a driver assistance system such as, for example, a video monitoring system, which automatically initiates the emergency stop if the vehicle is approaching an obstacle at too high a speed.

It is known from the existing art to brake a vehicle in the context of an emergency stop firstly to a predetermined low speed with the aid of the service brake, then to release the service brake and to brake the vehicle to a standstill using the parking brake. The vehicle is then, at a standstill, usually prevented from rolling away. A perceptible jerk occurs upon release of the service brake and application of the parking brake, however, and is perceived by the driver as uncomfortable. In addition, during the time between release of the service brake and application of the parking brake, the wheels briefly roll freely and the vehicle is not decelerated.

It is therefore an object of the present invention to achieve uniform and continuous braking behavior by the vehicle during an emergency stop.

### SUMMARY OF THE INVENTION

One important idea of the present invention is that of actuating the service brake and a second braking system (preferably a parking brake) at least at times simultaneously, and “cross-fading” the braking action of the service brake over to the second braking system, i.e. reducing the proportion of the service brake and increasing the proportion of the second braking system. This has the substantial advantage that a uniform, uninterrupted braking operation can be performed.

The service brake can be any known hydraulic, mechanical, or electromechanical braking system. The associated positioning members are correspondingly, for example, a hydraulic accessory (hydraulic pump), a Bowden cable, or electric motors with which the braking pressure of a wheel brake can be varied.

The term “second braking system” is to be understood, according to the present invention, as any system independent of the service brake, such as e.g. a separate parking brake, with which the vehicle can be decelerated. The second braking system can likewise have a mechanical, electromechanical, hydraulic, or pneumatic positioning member and can act on the same braking device (e.g. a disc brake) as, or a different one from, the service braking system.

According to a preferred embodiment of the present invention, after initiation of an emergency stop at first only the positioning member of the service brake is actuated, provided the vehicle speed is above a predetermined threshold. Until the speed threshold is reached, the vehicle is decelerated exclusively by the service brake. After the speed threshold is reached, or if the vehicle speed was lower than the threshold value from the outset, the second braking system is then switched in and the vehicle is decelerated by both braking systems simultaneously. The braking effect of the service brake is reduced as the braking operation proceeds, and that of the second braking system increased. The result is, in particular, to rule out locking of the vehicle's wheels at high speed because of the action of the second braking system.

The function with which the braking effect of the service braking system is reduced, and that of the second braking system is increased, is preferably selected in such a way that the same or approximately the same total braking pressure is exerted at each point in time during the braking operation. This has the substantial advantage that the braking behavior of the vehicle does not change.

The control system for the positioning members is preferably designed in such a way that the braking pressure exerted by the service brake decreases linearly and the braking pressure exerted by the second braking system rises linearly. The result is, in particular, to achieve a continuous profile for the total braking force.

According to a preferred embodiment of the present invention, during an emergency stop the vehicle is preferably braked to a standstill by both braking systems. The best braking effect can thereby be achieved. Once the vehicle is at a standstill, the parking brake is preferably set and the vehicle is prevented from rolling away.

Optionally, during an emergency stop the vehicle also can be braked with both braking systems only down to a predetermined speed, and once the speed threshold is exceeded can then be braked using only the second braking system.

The emergency stop can additionally be assisted by a further braking system, such as e.g. a retarder used in commercial motor vehicles. Alternatively, for example, the engine drag torque or a transmission apparatus can also be employed for additional deceleration of the vehicle.

### BRIEF DESCRIPTION OF THE DRAWINGS

FIG. 1 is a schematic block depiction of an emergency stop system.

FIG. 2 shows the change in braking pressure at the service brake and at a parking brake during an emergency stop.

FIG. 3 shows the important method steps upon implementation of an emergency stop.

### DETAILED DESCRIPTION

FIG. 1 is a block depiction of the important elements of an emergency stop system. In the present case that system encompasses two braking systems, namely a service brake having components 1, 3, and 6, and a second braking system independent thereof (e.g. a parking brake) having components 2, 3, and 6. Optionally, more than two braking systems could also be provided.

The service brake encompasses a positioning member 1 such as, for example, a hydraulic pump, with which a wheel brake 6 can be actuated. Second braking system 2, 3, 6 encompasses a positioning member 2 such as, for example, an electric motor, with which the braking pressure acting on wheel brake 6 can be varied. In the present example both positioning members 1, 2 act on the same braking apparatus, namely the brake caliper of a wheel brake 6. Optionally, positioning members 1, 2 can also act on different braking apparatuses, for example positioning member 1 on the brake caliper of a disc brake and positioning member 2 on the brake shoe of a drum brake. Both positioning members 1, 2 are connected to a control unit 3 and can be triggered thereby independently of one another.

The emergency stop system furthermore encompasses an operating element 4, such as e.g. a pushbutton, for initiating an emergency stop. The emergency stop system can also, alternatively or additionally, encompass a driver assistance system 5 such as, for example, a video monitoring system, that observes the vehicle's surroundings and detects critical driving situations. An automatic emergency stop is initiated if the vehicle approaches an obstacle at too high a speed.

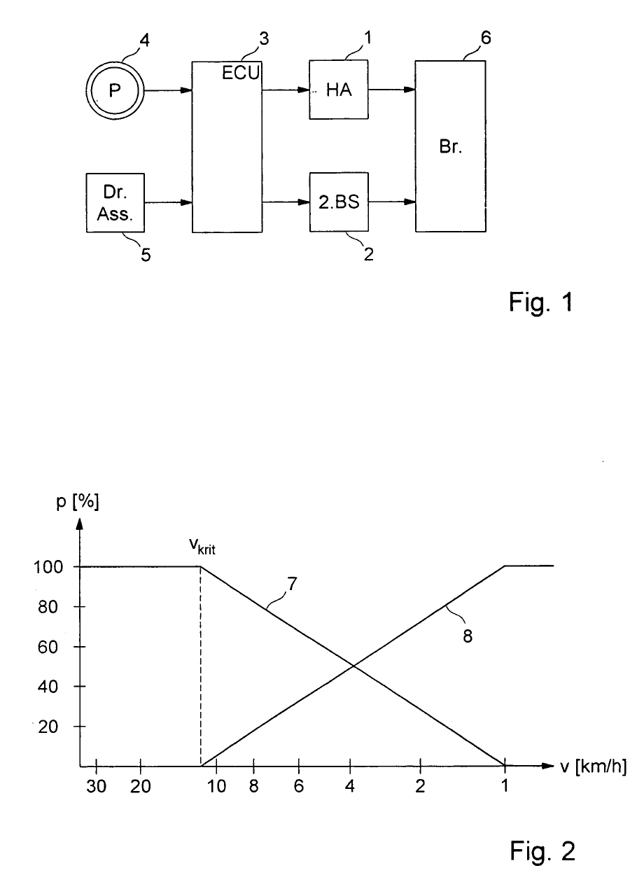

After initiation of an emergency stop, positioning members 1 and 2 are triggered by control unit 3 as a function of vehicle speed. Braking pressure is distributed to the two braking systems as depicted by way of example in FIG. 2.

FIG. 2 shows the profile of braking pressure p acting on wheel brake 6 in the context of an emergency stop, plotted against vehicle speed v. Curve 7 describes braking pressure p of the service braking system, and curve 8 the braking pressure p of the additional braking system. As is evident, at high vehicle speeds above a predetermined speed threshold v_{crit}, positioning member 1 generates all the braking pressure (100%), and the second braking system is not active. Once speed threshold v_{crit} is reached, the braking pressure exerted by positioning member 1 is reduced linearly toward zero, while the braking pressure exerted by positioning member 2 is increased linearly toward 100%. The slopes of the straight lines can be of identical absolute magnitude, or can also deviate from one another. The profiles of the individual braking pressures 7, 8 should, however, preferably be selected in such a way that the sum of the total braking pressure is as constant as possible over time. The critical speed v_{crit} is preferably located at values less than 20 km/h, preferably between 15 km/h and 10 km/h.

In the present example, the vehicle is not braked entirely to a standstill by both braking systems simultaneously. Shortly before the vehicle reaches a standstill, positioning member 1 of service brake 1, 3, 6 is completely deactivated and the vehicle is then braked only by the other braking system 2, 3, 6. Once the vehicle has come to a standstill, the parking brake is set.

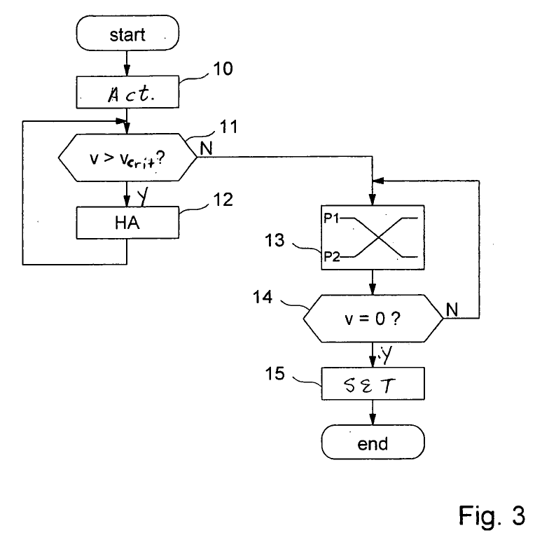

FIG. 3 once again shows the important method steps when carrying out an emergency stop. After initiation of an emergency stop, a check is first made as to whether vehicle speed v is greater than a predetermined threshold value v_{crit}. If the speed is greater (Y), in step 12 initially only positioning member 1 of the service brake is triggered in order to decelerate the vehicle. If the vehicle speed falls below threshold value v_{crit} or was less than threshold value v_{crit} from the outset (N), the second braking system is additionally activated. As the braking operation proceeds, the braking effect of the service brake is then reduced in predetermined fashion and the braking effect of second braking system 2, 3, 6 is increased in predetermined fashion (step 13). Step 14 checks whether the vehicle has already come to a standstill. If No, the braking pressure is further modified. If Yes, then in step 15 the parking brake is set and the vehicle is thereby prevented from rolling away. This terminates the method.

### LIST OF REFERENCE CHARACTERS

1 Positioning member for service brake
2 Positioning member for second braking system
3 Control unit
4 Operating element
5 Driver assistance system
6 Wheel brake
10-15 Method steps

What is claimed is:

1. A method for braking a vehicle in the context of an emergency stop with the aid of a service braking system and a second braking system, the service braking system and the second braking system including first and second positioning members, respectively, for exerting braking pressure, the method comprising:
actuating simultaneously, at least at times, the first positioning member and the second positioning member;
reducing a braking pressure exerted by the first positioning member in the course of a braking operation; and
increasing a braking pressure exerted by the second positioning member.

2. The method according to claim 1, wherein the braking pressure exerted by the first positioning member decreases linearly, and the braking pressure exerted by the second positioning member rises linearly.

3. The method according to claim 1, further comprising:
at vehicle speeds that are above a predetermined threshold, actuating initially only the first positioning member; and
additionally actuating the second positioning member when a speed falls below a predetermined threshold value.

4. The method according to claim 1, further comprising braking the vehicle to a standstill with both braking systems.

5. The method according to claim 1, further comprising:
braking the vehicle to a predetermined speed with both braking systems; and
after a speed falls below a value, braking the vehicle only by way of the second braking system.

6. The method according to claim 1, wherein the second braking system is a parking brake.

7. A braking system having an emergency stop function, the braking system comprising:
a service braking system including a first positioning member;
a second braking system including a second positioning member; and
a control unit for automatically triggering the first and second positioning members in the context of an emergency stop, the control unit being set up in such a way that the first and second positioning members are at least at times triggered simultaneously, a braking pressure exerted by the first positioning member being reduced in the course of a braking operation, and a braking pressure exerted by the second positioning member being increased.

8. A vehicle comprising a braking system having an emergency stop function, the braking system including:
a service braking system including a first positioning member;
a second braking system including a second positioning member; and
a control unit for automatically triggering the first and second positioning members in the context of an emergency stop, the control unit being set up in such a way that the first and second positioning members are at least at times triggered simultaneously, a braking pressure exerted by the first positioning member being reduced in the course of a braking operation, and a braking pressure exerted by the second positioning member being increased.
